(19) United States
(12) Patent Application Publication
(10) Pub. No.: US 2004/0153184 A1
(43) Pub. Date: Aug. 5, 2004

(54) Design aiding apparatus, design aiding method and design aiding program

(75) Inventor: Tatsuro Shima, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 10/747,136

(22) Filed: Dec. 30, 2003

(30) Foreign Application Priority Data
Jan. 17, 2003 (JP) 2003-9382

(51) Int. Cl. G06F 19/00

(52) U.S. Cl. 700/97; 700/95; 700/98

(57) ABSTRACT

A design aiding apparatus is provided in which even if some of parts information on a product device are missing, they can be properly supplemented, and in which by using the information on the levels of respective pieces of information, there is substantially no variation in the reliabilities of respective values to be added in numerical calculation, thus making it possible to carry out evaluation with a desired level of reliability. The apparatus calculates values for prescribed information on a prescribed device by using parts information representative of information on parts forming the device, and attribute information representative of attributes of the parts. The apparatus can set the attribute information and accuracy information representative of the level of reliability on the attribute information. Upon calculation of the values, the accuracy information is thus set so that numerical calculation is carried out by using attribute information that satisfies the accuracy information.

### BACKGROUND OF THE INVENTION

1. Field of the Invention

The present invention relates to a design aiding apparatus, a design aiding method and a design aiding program capable of calculating values for prescribed pieces of information related to an environmental issue with respect to a product device by using, for example, parts information, which indicates information on parts forming the product device and is obtained from CAD (Computer Aided Design), and attribute information indicating the attributes of the parts such as their weights, CO₂ emission factors, etc.

2. Description of the Related Art

In the past, there have been known design aiding apparatuses or the like which are capable of calculating values for prescribed pieces of information on a product device related to an environmental issue, by using the data of parts information on the product device obtained by CAD.

In such apparatuses, attribute information on each of the parts is acquired from a database or the like by tracing a configuration tree, which hierarchically represents the component parts of the product device, from its head by the use of a computer, so that the values for prescribed pieces of information are calculated by using the attribute information thus acquired, and the result of calculations are displayed. Thus, the user can evaluate or assess the developed product device or the like based on this calculation result.

For example, in the numerical calculation of CO₂ emission, the weights of respective component parts forming a product are acquired, and then multiplied by their CO₂ emission factors, respectively, so that such calculations are carried out for all the component parts, with the results thus obtained being added up to provide a total sum. Here, note that the weight of each component part can be acquired by multiplying the volume data thereof based on the shape data thereof obtained from CAD data for example by the specific gravity of a material in the form of the attribute of the part (for example, see a first non-patent electronic document listed below).

the first non-patent electronic document: http://salesgroup.fujitsu.com/plm/fjvps/public/proposal/proposal_eco.html

However, such a known design aiding apparatus merely makes use of the parts information obtained from CAD as it is, and hence there might be some parts that actually exist in the product device as mentioned above, but their data is not included in the CAD data.

For example, information for those parts as mentioned above does not exist, or even if such parts information does exist, their shape data might not exist, so their weights could not be obtained from their volumes. In addition, in the case of a composite part comprising a plurality of component elements, there might sometimes exist no information on the respective component elements and hence it is impossible to obtain the weights and/or CO₂ emission factors of the respective component elements. In such a case, any reliable assessment or evaluation of the product device can not be made.

Moreover, the known design aiding apparatus has no guideline for representing the level of reliability for each piece of above-mentioned information or the level of significance thereof in calculating values for the above-mentioned prescribed pieces of information by using the above-mentioned respective pieces of information. As a result, if there is a variation in the reliability levels of those pieces of information or if those pieces of information are changed, it would become uncertain to what extent such an evaluation can be relied upon, and hence in this case too, no reliable evaluation can not be obtained.

### SUMMARY OF THE INVENTION

Accordingly, the present invention is intended to solve the problems as referred to above, and has for its object to provide a design aiding apparatus, a design aiding method and a design aiding program in which parts information in the product device, even if missing, can be properly supplemented, and in which by using information on the reliability level of each piece of information, there is no variation in the reliability of each value to be added for numerical calculation, thus making it possible to conduct assessment or evaluation with a desired reliability level.

In order to achieve the above object, according to one aspect of the present invention, there is provided a design aiding apparatus for calculating values for prescribed information on a prescribed device by using parts information representative of information on parts forming the device, and attribute information representative of attributes of the parts, the apparatus comprising: an attribute information setting section that sets attribute information representative of attributes of the parts corresponding to the parts information; and an accuracy information setting section that sets accuracy information representative of the level of reliability of the attribute information that indicates attributes of the parts corresponding to the parts information, or significance in calculating the values for the prescribed information by using the attribute information.

According to such a configuration, the accuracy information can be attached to the attribute information so that a variety of kinds of processes can be carried out based on the accuracy information thus attached.

Preferably, the design aiding apparatus of the present invention further comprises: an accuracy information designation section that designates the accuracy information; an attribute information extraction section that extracts attribute information on an accuracy designated by the accuracy information designation section; and a calculation section that calculates the values for the prescribed information based on the attribute information extracted by the attribute information extraction section.

According to such a configuration, the numerical calculation of the prescribed information can be performed only for the attribute information having the designated accuracy, and hence it is possible to prevent the reliability used for the numerical calculation from being varied according to every attribute, thus making it possible to perform a reliable design aid.

According to another aspect of the present invention, there is provided a design aiding apparatus comprising: a parts information storage section that stores parts information representative of information on parts forming a prescribed device; an attribute information storage section that stores attribute information representative of attributes of the parts; an accuracy information storage section that stores accuracy information representative of the level of reliability of the attribute information or significance in calculating values for prescribed information on the device by using the attribute information; an attribute information setting section that stores the attribute information in the attribute information storage section; an accuracy information setting section that stores the accuracy information in the accuracy information storage section; an accuracy information designation section that designates the accuracy information; and a calculation section that extracts the attribute information from the attribute information storage section based on the accuracy information designated by the accuracy information designation section, and calculates the values for the prescribed information of the device.

Preferably, the attribute information includes: first attribute information representative of the names of materials forming the parts; and second attribute information representative of parameters necessary to calculate the values for the prescribed information on materials represented by the material names.

Preferably, the second attribute information includes at least either one of the weight, the CO₂ emission factor, the specific gravity and the recycle rate of each of the materials represented by the material names. In addition, the accuracy information setting section sets accuracy information on the second attribute information.

Preferably, the accuracy information setting section sets a plurality of pieces of accuracy information corresponding to a plurality of pieces of the second attribute information, respectively. According to this configuration, even when one value is obtained by using the plurality of pieces of attribute information, the reliability of each piece of attribute information can be designated, thereby making the advantage of the present invention more effective.

Preferably, those parameters, among the second attribute information, which are determined by the materials represented by the material names are managed in a unified manner by a database. Thus, when the parameters are varied according to the materials, the parameters can be changed in bulk or collectively so that the numerical result can also be reviewed easily.

Preferably, the second attribute information includes attribute information which is not managed in a unified manner by the database. Accordingly, it is possible to easily set a physical quantity such as weight or the like, which is not determined only by the property of a material such as the specific gravity thereof, thus resulting in convenience for numerical calculation.

Preferably, the design aiding apparatus of the present invention further comprises a parts information hierarchical display section that displays the parts information in a hierarchical manner so as to show a relation between each assembled part and respective component parts thereof forming the assembled part. According to this configuration, it is possible to readily recognize information lacking for the numerical calculation of the prescribed information in the component part information obtained from CAD for example.

Preferably, the parts information comprises information supplied from CAD. Thus, by using the parts information obtained from CAD, the design work for a product device can be performed in a consistent manner, thus making it possible to aid the improvement in efficiency of the design work.

In a further aspect of the present invention, there is provided a design aiding method for calculating values for prescribed information on a prescribed device by using parts information representative of information on parts forming the device, and attribute information representative of attributes of the parts, the method comprising the steps of: setting attribute information on parts corresponding to the parts information; setting accuracy information representative of the level of reliability of the attribute information or significance in calculating the values for the prescribed information by using the attribute information; extracting the attribute information on parts having attribute information on an accuracy which is designated and input; and calculating the values for the prescribed information based on the attribute information thus extracted.

In a still further aspect of the present invention, there is provided a design aiding program for making a computer execute a design aiding method of calculating values for prescribed information on a prescribed device by using parts information representative of information on parts forming the device, and attribute information representative of attributes of the parts, the program adapted to make the computer execute: an attribute information setting step of setting attribute information representative of attributes of the parts corresponding to the parts information; and an accuracy information setting step of setting accuracy information representative of the level of reliability of the attribute information that indicates attributes of the parts corresponding to the parts information, or significance in calculating the values for the prescribed information by using the attribute information.

Preferably, the design aiding program of the present invention further comprises an accuracy information designation step of designating the accuracy information; an attribute information extraction step of extracting attribute information having the accuracy information designated in the accuracy information designation step from among the attribute information set in the attribute information setting step; and a calculation step of calculating the values for the prescribed information based on the attribute information thus extracted.

In a yet further aspect of the present invention, there is provided a design aiding program for making a computer implement a design aide in a design aide apparatus which includes: a parts information storage section that stores parts information representative of information on parts forming a prescribed device; an attribute information storage section that stores attribute information representative of attributes of the parts; an accuracy information storage section that stores accuracy information representative of significance in calculating values for prescribed information on the prescribed device by using the attribute information or the level of reliability of the attribute information, wherein the values for prescribed information on the device are calculated by using the parts information and the attribute information thus stored. The program comprises: an attribute information storage step of storing the attribute information in the attribute information storage section; an accuracy information storage step of storing the accuracy information in the accuracy information storage section; an accuracy information designation step of designating the accuracy information; and a calculation step of extracting the attribute information from the attribute information storage section based on the accuracy information designated in the accuracy information designation step, thereby to calculate the values for the prescribed information of the device.

Preferably, the attribute information includes first attribute information representative of the names of materials forming the parts, and second attribute information representative of parameters necessary to calculate the values for the prescribed information on materials represented by the material names.

Preferably, the second attribute information includes at least either one of the weight, the CO₂ emission factor, the specific gravity and the recycle rate of each of the materials represented by the material names. In addition, the accuracy information storage step stores accuracy information on the second attribute information. Preferably, the accuracy information storage section stores a plurality of pieces of accuracy information corresponding to a plurality of pieces of the second attribute information, respectively.

Preferably, in the design aiding program of the present invention, those parameters, among the second attribute information, which are determined by the materials represented by the material names are managed in a unified manner by a database. In addition, the second attribute information includes attribute information which is not managed in a unified manner by the database.

Preferably, the design aiding program of the present invention further comprises a parts information hierarchical display step of displaying the parts information in a hierarchical manner so as to show a relation between each assembled part and respective component parts thereof forming the assembled part. In addition, in the design aiding program of the present invention, the parts information comprises information supplied from CAD.

Further, according to the present invention, there is provided a design aiding program for making a computer execute a design aiding method of calculating values for prescribed information on a prescribed device by using parts information representative of information on parts forming said prescribed device, and attribute information representative of attributes of said parts, the design aiding program being adapted to make the computer execute: a step of setting attribute information on parts corresponding to the parts information; a step of setting accuracy information representative of the level of reliability of the attribute information or significance in calculating the values for the prescribed information by using the attribute information; a step of extracting the attribute information on parts having attribute information on an accuracy which is designated and input; and a step of calculating the values for the prescribed information based on the attribute information thus extracted.

Here, note that this program can be stored in a computer readable medium, and the computer readable medium includes a portable storage medium such as a CD-ROM, a flexible disk, a DVD disk, a magneto-optical disk, an IC card or the like, or a database that holds therein computer programs, or another computer and its database, or a transmission medium on a communication line.

The above and other objects, features and advantages of the present invention will become more readily apparent to those skilled in the art from the following detailed description of a preferred embodiment of the present invention taken in conjunction with the accompanying drawings.

### BRIEF DESCRIPTION OF THE DRAWINGS

FIG. 1 is a block diagram showing a design aiding apparatus according to a first embodiment of the present invention.

FIG. 2 is a view showing a parts information confirmation screen.

FIG. 3 is a view showing parts information and attribute information in a list-like manner.

FIG. 4 is a view showing a printed circuit board unit and its materials.

FIG. 5 is a view showing an example of setting attribute information.

FIGS. 6(A) and 6(B) are views showing a material setting dialog screen and a material editing dialog screen, respectively.

FIG. 7 is a view showing one example of the material related information stored in a materials database.

FIG. 8 is a view showing an operation of numerically calculating CO₂ emission.

FIG. 9 is a view showing an input screen for setting an accuracy level.

FIG. 10 is a view showing a summary display screen to display the result of numerical calculations.

### DESCRIPTION OF THE PREFERRED EMBODIMENT

Now, a preferred embodiment of the present invention will be described below in detail while referring to the accompanying drawings.

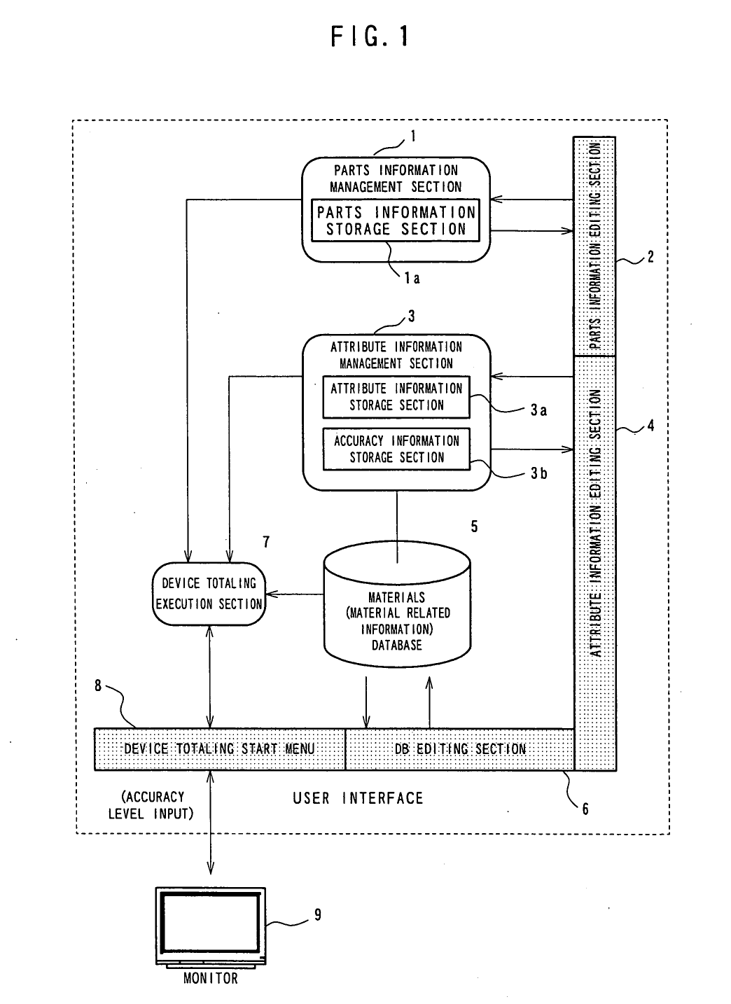

FIG. 1 is a block diagram that shows the configuration of a design aiding apparatus according to the present invention. This design aiding apparatus includes: parts information management section 1 that manages the information of parts forming a product device, the information being obtained from CAD data for example; a parts information editing section 2 that has the function of editing the parts information managed by the parts information management section 1; an attribute information management section 3 that manages attribute information representing the attributes of the parts represented by the parts information; an attribute information editing section 4 that has the function of editing the attribute information managed by the attribute information management section 3; a materials database 5 that stores, amongst various pieces of attribute information, prescribed attribute information (material related information) on the values of material properties or the like, which are determined by materials once decided to be used; a database editing section 6 that has the function of editing the attribute information stored in the materials database 5; a device totaling execution section 7 that calculates, as the prescribed values (evaluation values) in the product device, values related to an environmental issue, such as, for instance, CO₂ emissions, recycle rates, etc., by using various information from the parts information management section 1, the attribute information management section 3 and the materials database 5; a device totaling start menu 8 that operates the device totaling execution section 7 according to a desired menu; and a monitor 9 that displays the process and/or result of an operation according to the device totaling start menu 8.

Incidentally, the parts information management section 1 includes a parts information storage section 1a that stores the information of the parts of the product device, and the attribute information management section 3 includes an attribute information storage section 3a that stores attribute information, and an accuracy information storage section 3b that stores accuracy information to be described later in detail.

Here, note that the respective editing sections 2, 4, 6 and the device totaling start menu 8 together constitute a user interface. In addition, the parts information and the attribute information are mutually linked with each other through identifiers. Also, prescribed attribute information such as, for example, material names among various pieces of attribute information are linked with the attribute information such as material related information stored in the materials database 5.

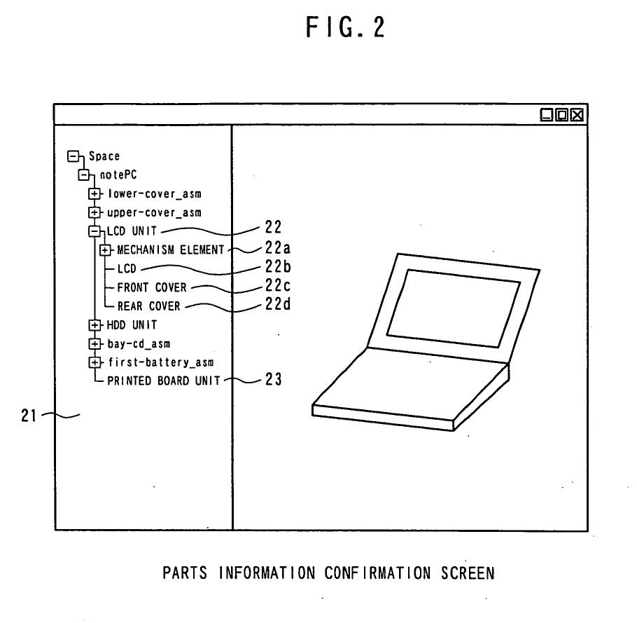

In the design aiding apparatus as constructed above, for example, when a user tries to confirm parts information (configuration information) of a certain prescribed product device on the screen of the monitor 9, a screen as illustrated in FIG. 2 is displayed. FIG. 2 shows a parts information confirmation screen in the case of a notebook computer being taken as an example of the product device. Parts forming the notebook computer are displayed in a left window 21 of FIG. 2 in a tree structure so as to show the parts of the notebook computer in a hierarchical manner.

That is, with respect to an LCD unit 22 for example as one of the parts constituting the notebook computer, respective component parts such as a mechanism element 22a, an LCD 22b, a front cover 22c, a rear cover 22d and the like, which together constitute the LCD unit 22, are branched therefrom. Thus, on the parts information confirmation screen, there are hierarchically displayed an assembled part (LCD unit 22) and its respective component parts (22a-22d) constituting the assembled part in a manner so as to illustrate the relation therebetween.

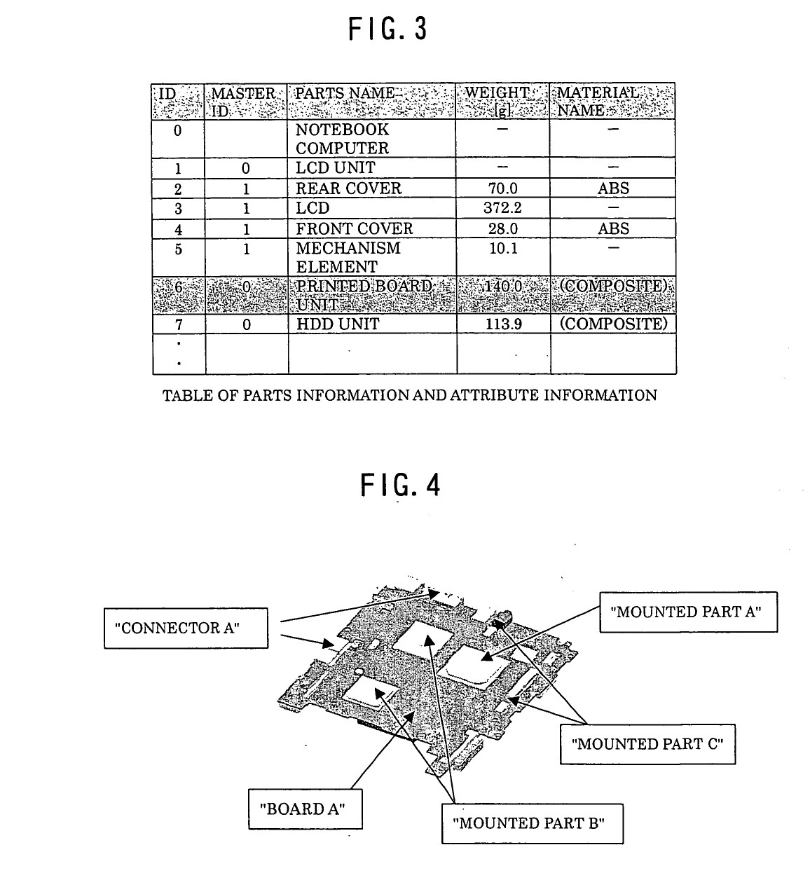

The parts information is linked with attribute information in such a manner that the parts information and the attribute information are exemplarily illustrated in a list-like manner in FIG. 3. These pieces of information are also device configuration information provided from CAD to the design aiding apparatus of the present invention. According to FIG. 3, an ID in the form of a first identifier is attached to each piece of the parts information in the form of part names, and in addition, an ID of an assembled part is attached to the respective component parts of the assembled part (e.g., LCD unit) as a second identifier (a master ID).

Moreover, each piece of configuration information (part names) has, as its attributes, its weight (g) and its material name attached thereto. Here, note that in a printed circuit board unit (e.g., an ID of 6 and a master ID of 0), its material name is “composite”, and respective pieces of component parts information (material names) constituting the unit are not provided.

According to the apparatus of the present invention, these pieces of component parts information in the form of material names can be set and input as attribute information (first attribute information), and at the same time, various kinds of information related to the attribute information (e.g., accuracy levels (corresponding to accuracy information of the present invention) and weights included in the second attribute information) can also be set and input. Hereafter, these will be explained in detail.

FIG. 4 shows a printed circuit board unit along with the names of its component materials (first attribute information) including “CONNECTOR A”, “BASE A”, “MOUNTED PART B”, “MOUNTED PART C” AND “MOUNTED PART A”.

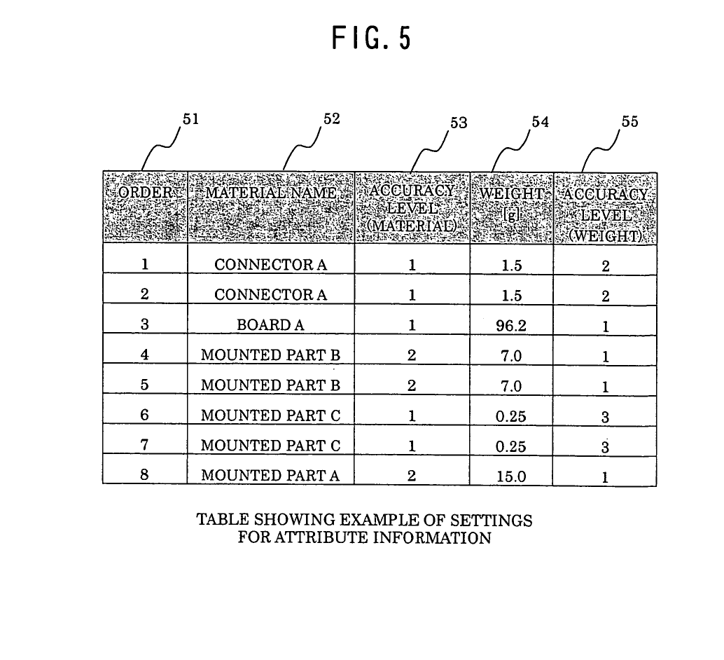

FIG. 5 shows one example (settings of attribute information) in which these material names and their related information to be described later are set as attribute information. According to FIG. 5, the material names (first attribute information) 52 of items or materials (component parts) forming the printed circuit board unit, accuracy levels (materials) 53, weights (second attribute information) 54, and accuracy levels (weights) 55 are set in correspondence to serial numbers (sequence numbers) 51.

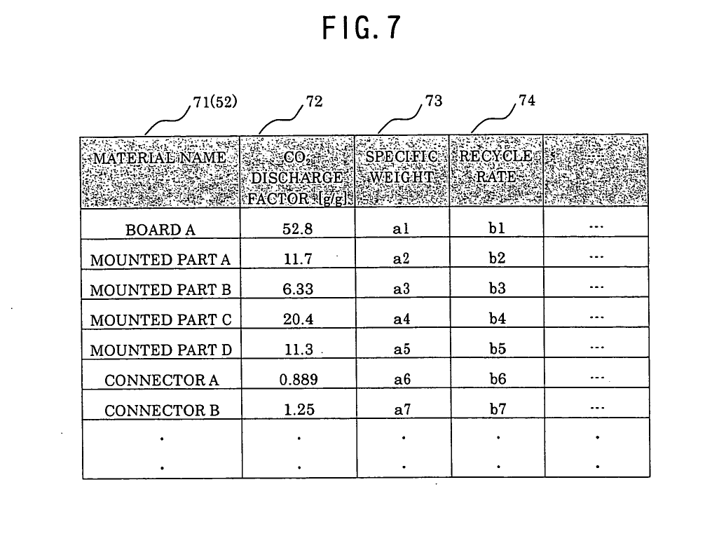

Here, note that an accuracy level (material) 53 represents the reliability (accuracy information) of the CO₂ emission factor set for the material indicated by an item or material name, and the CO₂ emission factor is a piece of second attribute information representing a parameter necessary to calculate the amount of CO₂ emission (hereinafter simply referred to as CO₂ emission) as in the case of the weight, but is stored, unlike the weight, in the materials database 5 as material related information unaffected by parameters other than the material (or volume in case of the weight) which is once decided, so that it is managed or controlled in a unified manner (see FIG. 7 to be described later).

Further, with respect to accuracy levels (materials) 53 as shown in FIG. 5, an accuracy level “1” indicates high reliability of the CO₂ emission factor, and an accuracy level “2” indicates medium reliability of the CO₂ emission factor, which is lower than the accuracy level “1” but higher than an accuracy level “3” though not shown in FIG. 5. In addition, “WEIGHT” indicates the weight of a material corresponding to each material name.

In addition, the accuracy levels (weights) 55 represent the reliabilities (significances) of weights attached to the respective materials, wherein an accuracy level “1” indicates that the weight is indispensable for numerical calculation (e.g., calculation of the CO₂ emission performed by using the weight)(i.e., the significance is high); an accuracy level “2” indicates that the significance of the weight is lower than the accuracy level “1” but higher than an accuracy level “3” to be described later (i.e., the significance is at a medium level); and an accuracy level “3” indicates that the accuracy of numerical calculation will be within an allowable level even if the weight is ignored in the numerical calculation (i.e., the significance is low).

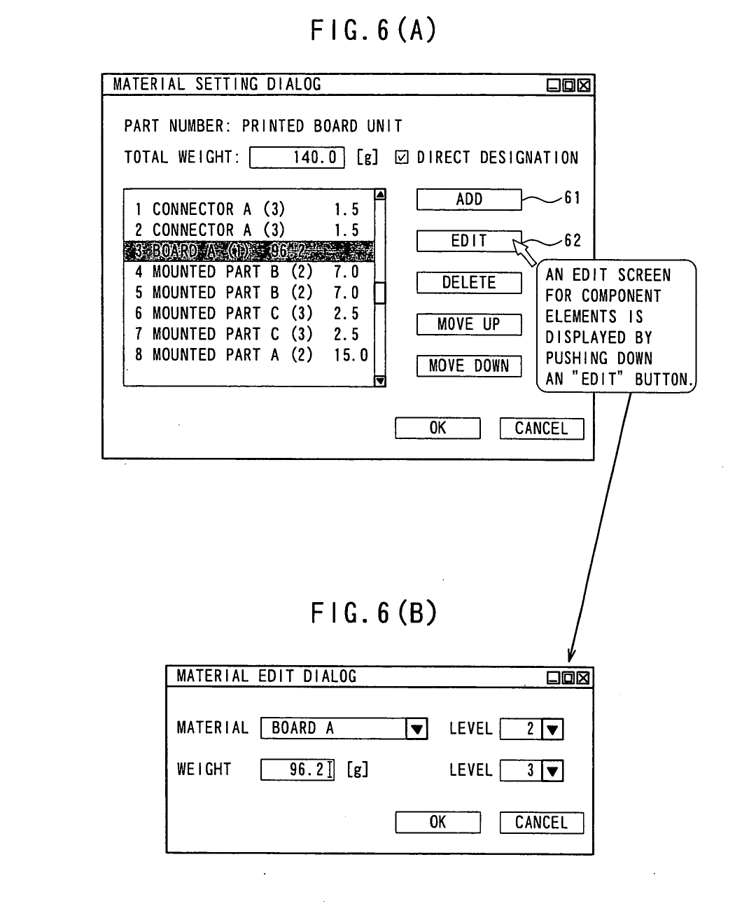

FIGS. 6(A) and 6(B) illustrate screens and operations for setting attribute information shown in FIG. 5, wherein FIG. 6(A) is a view that shows a material setting dialog screen, and FIG. 6(B) is a view that shows a material editing dialog screen. Illustrating one example of an attribute information setting operation, when the user operates to select a printed circuit board unit 23 in the left window 21 of FIG. 2, a material setting dialog screen is displayed, as illustrated in FIG. 6(A). Here, by pressing an add button 61, a highlighted material name can be set and input as attribute information (first attribute information). This add screen is substantially the same as a material editing dialog screen to be described later, and hence its illustration and explanation are omitted here. Here, note that on such an add screen, there may be displayed a list of the material names registered in the materials database as shown in FIG. 7, so that the user can add a material name through proper selection operation.

When setting and inputting an attribute (weight: second attribute information) of the material thus set and input or an accuracy level of the attribute (accuracy information), the user can do such operation by pressing an edit button 62 on the screen of FIG. 6(A) thereby to display a material editing dialog screen as illustrated in FIG. 6(B). In FIG. 6(B), the accuracy level of the CO₂ emission factor (second attribute information: material related information) for the base (A) can be input, and the weight (second attribute information) of the base (A) and the accuracy level thereof can also be set and input. Furthermore, on the material editing dialog screen, a change in the material name (first attribute information) can be performed. Incidentally, the add screen as mentioned above can be made a screen where a material name, weight and each level can be set and input as in the case of the material editing dialog screen.

FIG. 7 shows one example of the materials database, in which are stored a plurality of item or material names 71 and parameters necessary to calculate values related to an environmental issue, such as a CO₂ emission factor 72, a specific gravity 73, a recycle rate 74, etc., which are pieces of second attribute information on the plurality of item or material names 71, respectively. The parameters (material related information), whose values are determined without influenced by the other parameters if the materials are decided, are registered as environmental parameters.

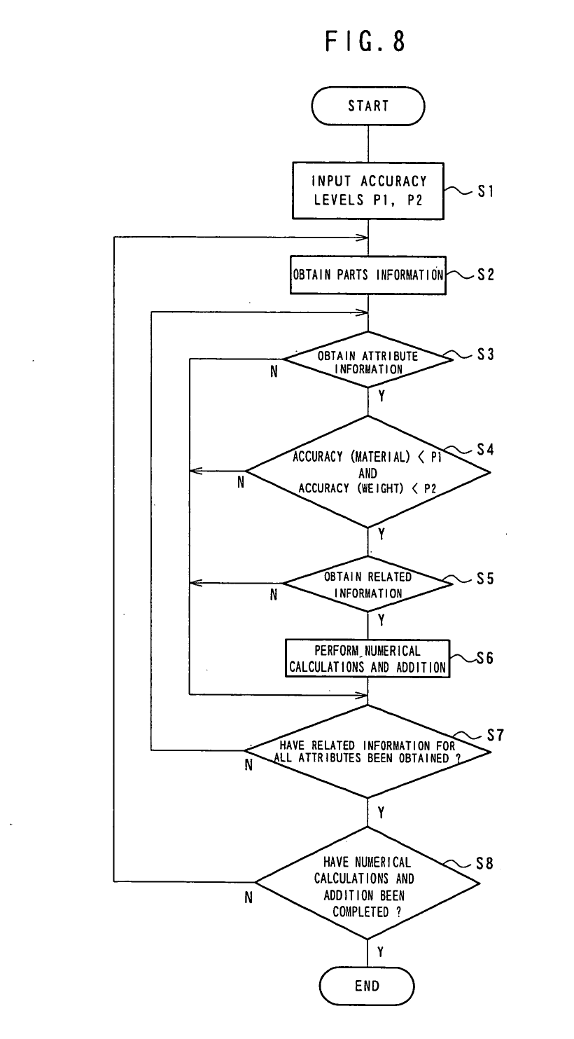

FIG. 8 is a flow chart that shows an example of operation when the numerical calculation of the CO₂ emission of the personal computer illustrated in FIG. 2 for example is carried out by using these various kinds of information as mentioned above. In this embodiment, it is possible to perform such numerical calculation (totaling) by using only the second attribute information having an accuracy higher than or equal to a desired accuracy level based on the accuracy information (accuracy level) thus set and input. Hereinafter, such an operation will be explained in detail.

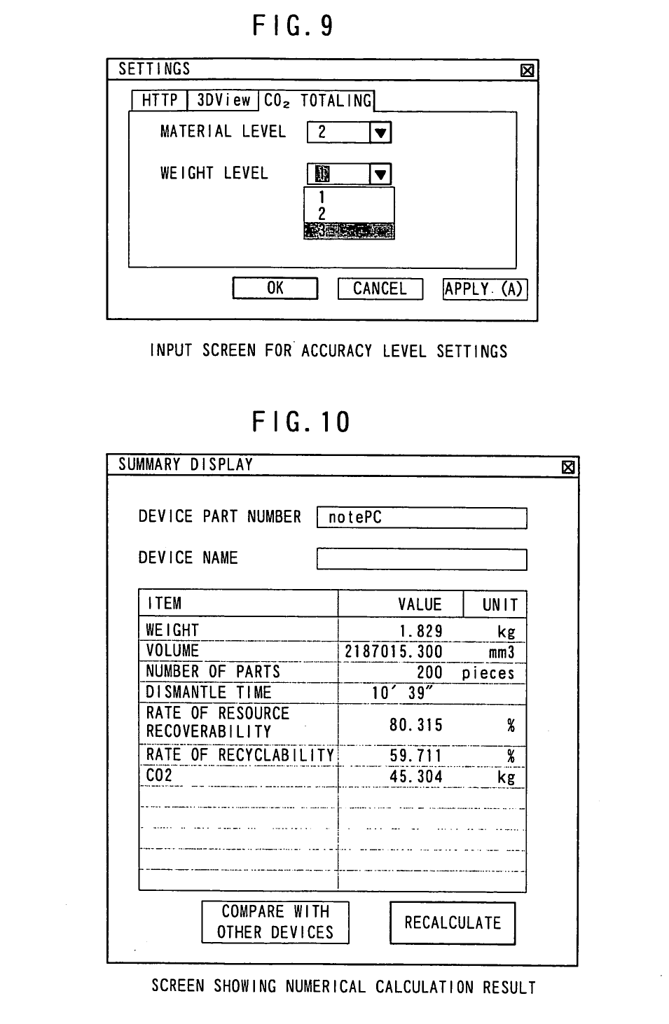

First of all, in step S1, for a CO₂ emission factor registered in the materials database as a piece of second attribute information, a boundary or threshold accuracy level (material) P1, which is low in reliability for example and hence should be excluded from calculation, is input. In addition, for a weight set and input as a piece of second attribute information, a boundary or threshold accuracy level P2, which is low in reliability (significance) for example and hence should be excluded from calculation, is input. FIG. 9 shows a screen (setting dialog) for inputting such settings, wherein the material level (accuracy (material)) P1 and the weight level (accuracy (weight)) P2 are set and input on the setting dialog screen. In this embodiment, only when the accuracy levels for the CO₂ emission factor and the weight (both being pieces of second attribute information) are less than the values indicated by P2, P1, respectively (the reliability and significance are high), the amount of CO₂ emission is calculated based on the values.

Then, in step S2, target parts contributing to the numerical calculation are acquired. These target parts are the parts corresponding to the part names with master IDs attached thereto as shown in FIG. 3. After the part names are acquired, then in step S3, it is determined whether certain pieces of attribute information are attached to the parts related to the part names, and whether such attribute information can be acquired. For example, material names (first attribute information) and weights (second attribute information) are recited as such attribute information. When such pieces of attribute information are acquired, then in step S4, the accuracies (i.e., the reliability of the CO₂ emission factor and the significance of the weight) set for the material names and the weight, respectively, are read, and it is determined whether these accuracies are less than P1 and P2, respectively.

When these accuracies are less than P1 and P2, respectively, then in step S5, it is determined whether the CO₂ emission factor, which is a piece of second attribute information on the material name, can be acquired from the materials database. When the CO₂ emission factor can be acquired, then in step S6, numerical calculation and accumulation (addition) are carried out so as to obtain the CO₂ emission. The calculation of the CO₂ emission is performed in the following manner.

the CO₂ emission of the device=Σ (parts CO₂ emission)

parts CO₂ emission=Σ (material emission)=Σ (material weight×CO₂ emission factor)

Here, the weight of each material, which has been set and input as second attribute information, are used as the above-mentioned material weight, but apart from this, in case where the volumes of parts can be found from CAD data, for example, with the specific gravities of the parts materials being registered in the materials database, it is possible to obtain the material weights by multiplying the material volumes by their corresponding specific gravities. In this case, it becomes necessary to set accuracies for the material specific gravities or accuracies for the material volumes.

Thus, after the numerical calculation is performed in step S6, then in step S7, it is determined whether the above-mentioned processes have been carried out for all the material names (first attribute information). In this manner, the processes from step S3 to step S6 are repeated until numerical calculations for all the material names are completed.

When any of the determinations is negative in the processes of steps S3 through S5, the process of step S6 is not carried out but skipped, and the process of step S7 is directly performed. When the determination in step S7 results in a positive one, it is further determined whether numerical calculations and accumulations (additions) have been carried out for all the pieces of parts information. When everything is finished, the processing is ended, whereas when everything has not yet been finished, the next new parts information is acquired and thereafter similar processes are repeated.

By storing a design aiding program including at least the processes of such steps S1 through S8 in a recording medium that can be read by a computer, it is possible to make the computer execute the numerical calculation of prescribed information (e.g., calculation of CO₂ emission) as a design aid according to the design aiding apparatus. Here, note that in the present invention, the computer readable recording medium includes a portable storage medium such as a CD-ROM, a flexible disk, a DVD disk, a magneto-optical disk, an IC card or the like, or a database that holds therein computer programs, or other computer and its database, or a transmission medium on a communication line.

Thus, when the numerical calculations of all the parts have been completed, the numerical calculation result of the CO₂ emission of the product device is displayed as a result of such calculations, as illustrated in FIG. 10. In FIG. 10. there are also displayed, along with the CO₂ emission, the weight, the volume, the number of parts, the dismantle time, the rate of resource recoverability and the rate of recyclability. Incidentally, note that though not illustrated, a list of the material names of the parts, whose accuracies are more than or equal to the accuracy level designated by the user, can be displayed.

Thus, according to this embodiment, since only the attributes and the relevant information with reliabilities higher than or equal to a desired accuracy level can be used in the calculation of the CO₂ emission, the reliability of the calculation result can be improved, and the user can easily know the items to be reviewed in the calculation result. Accordingly, it becomes easy to perform the evaluation and study of the product device.

Although in this embodiment, the numerical calculation of the CO₂ emission has been taken as an example, the weight and the recycle rate of the product device can also be calculated. In this case, the weight and the recycle rate of the device can be respectively calculated as follows.

the weight of the device=Σ (parts weight)

parts weight=Σ (material weight)

the recycle rate of the device=Σ (parts recycle weight)/device weight

parts recycle weight=Σ (material recycle weight)=Σ (material weight×recycle rate)

As described in detail in the foregoing, according to the present invention, there can be obtained a design aiding apparatus, a design aiding method and a design aiding program in which even if some of parts information on a product device are missing, they can be properly supplemented, and in which by using the information on the levels of respective pieces of information, there is substantially no variation in the reliabilities of respective values to be added in numerical calculations, thus making it possible to carry out evaluation with a desired level of reliability.

While the invention has been described in terms of a preferred embodiment, those skilled in the art will recognize that the invention can be practiced with modifications within the spirit and scope of the appended claims.

What is claimed is:

1. A design aiding apparatus for calculating values for prescribed information on a prescribed device by using parts information representative of information on parts forming said device, and attribute information representative of attributes of said parts,
said apparatus comprising:
an attribute information setting section that sets attribute information representative of attributes of said parts corresponding to said parts information; and
an accuracy information setting section that sets accuracy information representative of the level of reliability of said attribute information that indicates attributes of said parts corresponding to said parts information, or significance in calculating the values for said prescribed information by using said attribute information.

2. The design aiding apparatus as set forth in claim 1, further comprising:
an accuracy information designation section that designates said accuracy information;
an attribute information extraction section that extracts attribute information on an accuracy designated by said accuracy information designation section; and
a calculation section that calculates the values for said prescribed information based on said attribute information extracted by said attribute information extraction section.

3. A design aiding apparatus comprising:
a parts information storage section that stores parts information representative of information on parts forming a prescribed device;
an attribute information storage section that stores attribute information representative of attributes of said parts;
an accuracy information storage section that stores accuracy information representative of the level of reliability of said attribute information or significance in calculating values for prescribed information on said device by using said attribute information;
an attribute information setting section that stores said attribute information in said attribute information storage section;
an accuracy information setting section that stores said accuracy information in said accuracy information storage section;
an accuracy information designation section that designates said accuracy information; and
a calculation section that extracts said attribute information from said attribute information storage section based on the accuracy information designated by said accuracy information designation section, and calculates the values for the prescribed information of said device.

4. The design aiding apparatus as set forth in claim 1, wherein
said attribute information includes:
first attribute information representative of the names of materials forming said parts; and
second attribute information representative of parameters necessary to calculate the values for said prescribed information on materials represented by said material names.

5. The design aiding apparatus as set forth in claim 4, wherein said second attribute information includes at least either one of the weight, the CO₂ emission factor, the specific gravity and the recycle rate of each of the materials represented by said material names.

6. The design aiding apparatus as set forth in claim 4, wherein said accuracy information setting section sets accuracy information on said second attribute information.

7. The design aiding apparatus as set forth in claim 4, wherein said accuracy information setting section sets a plurality of pieces of accuracy information corresponding to a plurality of pieces of said second attribute information, respectively.

8. The design aiding apparatus as set forth in claim 4, wherein those parameters, among said second attribute information, which are determined by the materials represented by said material names are managed in a unified manner by a database.

9. The design aiding apparatus as set forth in claim 8, wherein said second attribute information includes attribute information which is not managed in a unified manner by said database.

10. The design aiding apparatus as set forth in claim 1, further comprising a parts information hierarchical display section that displays said parts information in a hierarchical manner so as to show a relation between each assembled part and respective component parts thereof forming said assembled part.

11. The design aiding apparatus as set forth in claim 1, wherein said parts information comprises information supplied from CAD.

12. A design aiding method for calculating values for prescribed information on a prescribed device by using parts information representative of information on parts forming said device, and attribute information representative of attributes of said parts,
said method comprising the steps of:
setting attribute information on parts corresponding to said parts information;
setting accuracy information representative of the level of reliability of said attribute information or significance in calculating the values for said prescribed information by using said attribute information;
extracting said attribute information on parts having attribute information on an accuracy which is designated and input; and
calculating the values for said prescribed information based on said attribute information thus extracted.

13. A design aiding program for making a computer execute a design aiding method of calculating values for prescribed information on a prescribed device by using parts information representative of information on parts forming said device, and attribute information representative of attributes of said parts,
said program adapted to make said computer execute:
an attribute information setting step of setting attribute information representative of attributes of said parts corresponding to said parts information; and
an accuracy information setting step of setting accuracy information representative of the level of reliability of said attribute information that indicates attributes of said parts corresponding to said parts information, or significance in calculating the values for said prescribed information by using said attribute information.

14. The design aiding program as set forth in claim 13, further comprising:
an accuracy information designation step of designating said accuracy information;
an attribute information extraction step of extracting attribute information having said accuracy information designated in said accuracy information designation step from among said attribute information set in said attribute information setting step; and
a calculation step of calculating the values for said prescribed information based on said attribute information thus extracted.

15. A design aiding program for making a computer implement a design aide in a design aide apparatus which includes: a parts information storage section that stores parts information representative of information on parts forming a prescribed device; an attribute information storage section that stores attribute information representative of attributes of said parts; and an accuracy information storage section that stores accuracy information representative of significance in calculating values for prescribed information on said prescribed device by using said attribute information or the level of reliability of said attribute information, wherein the values for prescribed information on said device are calculated by using said parts information and said attribute information thus stored;
said program comprising:
an attribute information storage step of storing said attribute information in said attribute information storage section;
an accuracy information storage step of storing said accuracy information in said accuracy information storage section;
an accuracy information designation step of designating said accuracy information; and
a calculation step of extracting said attribute information from said attribute information storage section based on the accuracy information designated in said accuracy information designation step, thereby to calculate the values for the prescribed information of said device.

16. The design aiding program as set forth in claim 13, wherein said attribute information includes first attribute information representative of the names of materials forming said parts, and second attribute information representative of parameters necessary to calculate the values for said prescribed information on materials represented by said material names.

17. The design aiding program as set forth in claim 16, wherein said second attribute information includes at least either one of the weight, the CO₂ emission factor, the specific gravity and the recycle rate of each of the materials represented by said material names.

18. The design aiding program as set forth in claim 16, wherein said accuracy information storage step stores accuracy information on said second attribute information.

19. The design aiding program as set forth in claim 16, wherein said accuracy information storage section stores a plurality of pieces of accuracy information corresponding to a plurality of pieces of said second attribute information, respectively.

20. The design aiding program as set forth in claim 16, wherein those parameters, among said second attribute information, which are determined by the materials represented by said material names are managed in a unified manner by a database.

21. The design aiding program according to claim 20, wherein said second attribute information includes attribute information which is not managed in a unified manner by said database.

22. The design aiding program as set forth in claim 13, further comprising a parts information hierarchical display step of displaying said parts information in a hierarchical manner so as to show a relation between each assembled part and respective component parts thereof forming said assembled part.

23. The design aiding program as set forth in claim 13, wherein said parts information comprises information supplied from CAD.
